(19) United States
(12) Patent Application Publication
(10) Pub. No.: US 2014/0197109 A1
(43) Pub. Date: Jul. 17, 2014

(54) PROCESS FOR REMOVING ONE OR MORE DISULFIDE COMPOUNDS

(71) Applicant: UOP, LLC, Des Plaines, IL (US)

(72) Inventors: Luigi Laricchia, Arlington Heights, IL (US); Daniel K. Aiken, Arlington Heights, IL (US)

(73) Assignee: UOP, LLC, Des Plaines, IL (US)

(21) Appl. No.: 13/741,771

(22) Filed: Jan. 15, 2013

(51) Int. Cl. B01D 17/04

(52) U.S. Cl. CPC B01D 17/045
USPC 210/708

(57) ABSTRACT

One exemplary embodiment can be a process for removing one or more disulfide compounds from a caustic stream. The process may include passing the caustic stream, previously contacted with a hydrocarbon stream for removing one or more thiol compounds, through a vessel containing a coalescing element to remove the one or more disulfide compounds downstream of a three-phase separator and a thiol oxidation zone.

### FIELD OF THE INVENTION

This invention generally relates to a process for removing one or more disulfide compounds from a caustic stream.

### DESCRIPTION OF THE RELATED ART

A sulfur removal process can extract mercaptan from a hydrocarbon stream to a caustic stream. Subsequently, the caustic stream can be oxidized to convert the mercaptans to one or more disulfides. When disulfides form, the majority can separate from the caustic in the disulfide separator. As such, the caustic can be removed as a separate phase. Although at least a majority of the disulfide has been removed, some amount of disulfide can remain in the caustic that can be extracted back into the product hydrocarbon and contribute to the overall sulfur in a hydrocarbon product. As an example, the estimated entrained disulfide in a circulating caustic from a simple two-stage wash oil settler, typically designed with 30 minutes residence time, is about 50 wppm.

Often to reduce the amount of disulfide in the caustic, a series of mixers and settlers can contact the caustic with a sulfur-free oil to remove the disulfide oil from the lean caustic. To attain lower levels of disulfide, additional mixers or settlers may be provided. Generally, minimizing additional mixer/settler combinations and/or reducing the size of this equipment are preferable to reduce capital costs. As refiners and chemical manufacturers have to meet more stringent sulfur specifications, increased reduction in the disulfide amounts is desired. However, adding additional mixers and settlers can increase capital and operating costs. As a consequence, there is a desire to achieve the required specifications while minimizing costs. Moreover, accumulated disulfides from the lean caustic can accumulate in the hydrocarbon product, which may be subsequently removed by an adsorptive removal process that may further add capital and utility cost to the project. Thus, any reduction of the amount of disulfide in the lean caustic can avoid the cost of subsequent removal in downstream treatment zones for the hydrocarbon product.

### SUMMARY OF THE INVENTION

One exemplary embodiment can be a process for removing one or more disulfide compounds from a caustic stream. The process may include passing the caustic stream, previously contacted with a hydrocarbon stream for removing one or more thiol compounds, through a vessel containing a coalescing element to remove the one or more disulfide compounds downstream of a three-phase separator and a thiol oxidation zone.

Another exemplary embodiment may be a process for removing one or more disulfide compounds from a caustic stream. Usually, the process can include obtaining the caustic stream containing one or more thiol compounds from an extraction zone, passing the caustic stream to a thiol oxidation zone, obtaining an oxidized caustic stream and sending the stream to a three-phase separator, passing a separated caustic stream from the three-phase separator to a vessel containing a coalescing element to remove the one or more disulfide compounds, obtaining a disulfide and wash oil stream from the vessel, and recycling the disulfide and wash oil stream upstream of the thiol oxidation zone.

A further exemplary embodiment can be a process for removing one or more disulfide compounds from a caustic stream. The process can include obtaining the caustic stream containing one or more thiol compounds from an extraction zone, passing the caustic stream to a thiol oxidation zone, obtaining an oxidized caustic stream and sending the stream to a three-phase separator, passing a separated caustic stream from the three-phase separator to a vessel containing a coalescing element to remove the one or more disulfide compounds, obtaining a disulfide and wash oil stream from the vessel, and recycling at least a portion of the disulfide and wash oil stream to the vessel.

In one exemplary embodiment, a vessel containing a coalescing material may communicate with a three-phase separator to receive a disulfide-tainted caustic. Such a coalescing material can include a coated or uncoated mesh, and can improve separation and reduce settler size and cost. Vessels can be installed in a new unit or built by modifying an existing vessel. In one exemplary embodiment, a circulating caustic from a two-stage wash oil containing a coated mesh may be in the range of about 5—about 25 wppm with a residence time of about 15 minutes.

### DEFINITIONS

As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules. Furthermore, a superscript “+” or “−” may be used with an abbreviated one or more hydrocarbons notation, e.g., C3⁺ or C3⁻, which is inclusive of the abbreviated one or more hydrocarbons. As an example, the abbreviation “C3⁺” means one or more hydrocarbon molecules of three carbon atoms and/or more. In addition, the term “stream” may be applicable to other fluids, such as aqueous and non-aqueous solutions of alkaline or basic compounds, such as sodium hydroxide.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “rich” can mean an amount of at least generally about 50%, and preferably about 70%, by weight, of a compound or class of compounds in a stream.

As used herein, the term “substantially” can mean an amount of at least generally about 80%, preferably about 90%, and optimally about 99%, by weight, of a compound or class of compounds in a stream.

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g., a screw, a nail, a bolt, a staple, or a rivet; an adhesive; or a solder.

As described herein, the term “coalescer” may be a device containing glass fibers or other material to facilitate separation of immiscible liquids of similar density.

As used herein, the term “immiscible” can mean two or more phases that cannot be uniformly mixed or blended.

As used herein, the term “phase” may mean a liquid, a gas, or a suspension including a liquid and/or a gas, such as a foam, aerosol, or fog. A phase may include solid particles. Generally, a fluid can include one or more gas, liquid, and/or suspension phases.

As used herein, the term “parts per million” may be abbreviated herein as “ppm” and “weight ppm” may be abbreviated herein as “wppm”.

As used herein, the term “mercaptan” typically means thiol and may be used interchangeably therewith, and can include compounds of the formula RSH as well as salts thereof, such as mercaptides of the formula RS⁻M⁺ where R is a hydrocarbon group, such as an alkyl or aryl group, that is saturated or unsaturated and optionally substituted, and M is a metal, such as sodium or potassium.

As used herein, the term “disulfides” can include dimethyldisulfide, diethyldisulfide, and ethylmethyldisulfide, and possibly other species having the molecular formula RSSR′ where R and R′ are each, independently, a hydrocarbon group, such as an alkyl or aryl group, that is saturated or unsaturated and optionally substituted. Typically, a disulfide is generated from the oxidation of a mercaptan-tainted caustic and forms a separate hydrocarbon phase that is not soluble in the aqueous caustic phase. Generally, the term “disulfides” as used herein excludes carbon disulfide (CS₂).

As used herein, the weight percent or ppm of sulfur, e.g., “wppm-sulfur” is the amount of sulfur, and not the amount of the sulfur-containing species unless otherwise indicated. As an example, methylmercaptan, CH₃SH, has a molecular weight of 48.1 with 32.06 represented by the sulfur atom, so the molecule is about 66.6%, by weight, sulfur. As a result, the actual sulfur compound concentration can be higher than the wppm-sulfur from the compound. An exception is that the disulfide content in caustic can be reported as the wppm of the disulfide compound.

As used herein, the term “mercaptan-tainted caustic” can mean a caustic having a typical level of one or more mercaptans after exiting an extraction zone and prior to treatment in a thiol oxidation zone. It may or may not have desired levels of other sulfur-containing compounds, such as one or more disulfides. Typically, “mercaptan-tainted caustic” may have up to about 1,000 wppm of one or more mercaptans.

As used herein, the term “disulfide-tainted caustic” can mean a caustic having been treated in a thiol oxidation zone and having desired levels of one or more thiols, but still has undesired levels of one or more disulfides. In some exemplary applications, if a lowered level of one or more disulfides is not desired, such a stream could be considered a regenerated or lean caustic. Generally, the level of disulfides can be about 150—about 300, wppm in caustic, or higher particularly if the stream is after a thiol oxidation zone and upstream of a separator.

As used herein, the term “lean caustic” is a caustic having been treated and having desired levels of sulfur, including one or more mercaptans and one or more disulfides for treating one or more C1-C5 hydrocarbons in an extraction zone.

As used herein, the term “regeneration” with respect to a solvent stream can mean removing one or more disulfide sulfur species from the solvent stream to allow its reuse.

As depicted, process flow lines in the figures can be referred to, interchangeably, as, e.g., lines, pipes, branches, distributors, streams, effluents, feeds, products, portions, catalysts, withdrawals, recycles, suctions, discharges, and caustics.

### BRIEF DESCRIPTION OF THE DRAWINGS

FIG. 1 is a schematic depiction of an exemplary apparatus.

FIG. 2 is a schematic depiction of another version of the exemplary apparatus.

### DETAILED DESCRIPTION

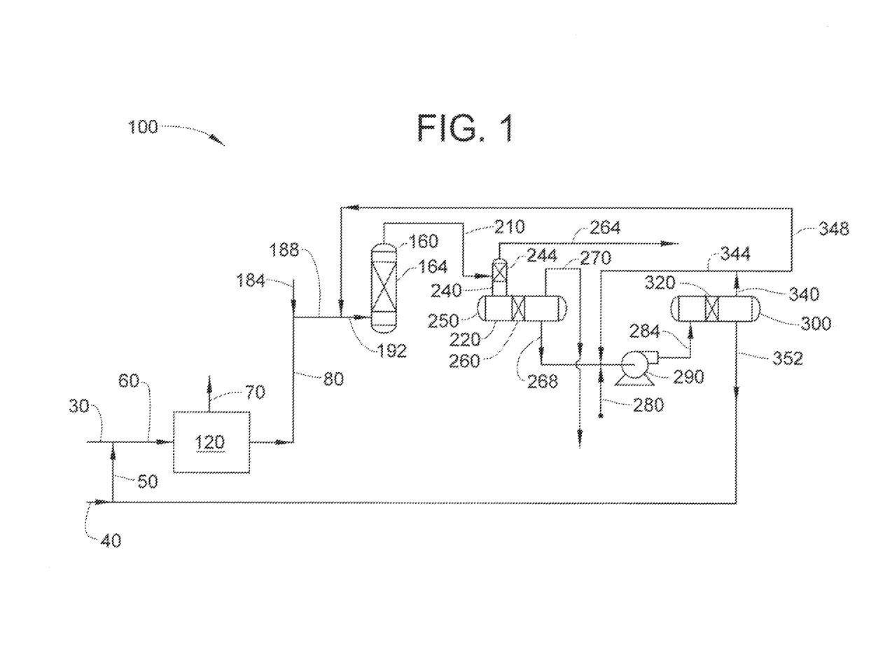

Referring to FIG. 1, an exemplary apparatus 100 for removing one or more disulfide compounds from a caustic stream 80 is depicted. Typically, the apparatus 100 can include an extraction zone 120, a thiol oxidation vessel 160, a three-phase separator 220, and a vessel 300. The vessels, lines and other equipment of the apparatus 100 can be made from any suitable material, such as carbon steel, stainless steel, or titanium. Generally, the apparatus 100 can also include a caustic prewash vessel. Exemplary apparatuses having at least a caustic prewash vessel, an extractor vessel, an oxidation vessel, and/or a separation vessel for removing sulfur-containing compounds from a hydrocarbon stream are disclosed in, e.g., U.S. Pat. No. 7,326,333 and US 2012/0000826.

The extraction zone 120 can receive a hydrocarbon stream 30, which is typically in a liquid phase and can include a fuel gas stream, a liquefied petroleum gas, or a naphtha hydrocarbon. Often, the hydrocarbon stream 30 contains sulfur compounds in the form of one or more mercaptans and/or hydrogen sulfide. A hydrocarbon stream 30 can be an effluent from, e.g., an amine absorber. The hydrocarbon stream 30 can include hydrogen sulfide and one or more C2-C8 hydrocarbons. Usually, the hydrocarbon stream 30 can include up to about 100 ppm, by weight, hydrogen sulfide. Generally, the hydrocarbon stream 30 is combined with a stream 50 including water from a stream 40, which may also include make-up caustic, and a caustic stream 352, as hereinafter described, for removing, e.g., hydrogen sulfide. The caustic can be any alkaline material, and generally includes caustic soda (NaOH) and caustic alcohol (C₂H₃ONa). The streams 30 and 50 are combined as an extractor feed 60. The extractor feed 60 can enter the extractor zone 120, which typically includes an extractor vessel, as disclosed in, e.g., US 2012/0000826. A hydrocarbon product 70 mostly free of mercaptans and mercaptides can be obtained from the extraction zone 120 while a spent caustic 80 including mercaptides can be withdrawn from the extraction zone 120.

The spent caustic 80 can be combined with an air stream 184, and optionally with an oxidation catalyst. The oxidation catalyst can be any suitable oxidation catalyst, such as a sulfonated metal phthalocyanine. However, any suitable oxidation catalyst can be used such as those described in, e.g., U.S. Pat. No. 7,326,333 B2.

The optional oxidation catalyst, the air stream 184, and the spent caustic 80 can be combined as a feed stream 192 before entering the oxidation vessel 160. The feed stream 192 may also include a recycle stream 348, as hereinafter described. The spent aqueous caustic and air mixture is distributed in the oxidation vessel 160.

In the oxidation vessel 160, the sodium mercaptides catalytically react with oxygen and water to yield caustic and organic disulfides. Optionally, the oxidation vessel 160 can include a packing 164, such as carbon rings, to increase the surface area for improving contact between the spent caustic and catalyst. Afterwards, an effluent 210 can be withdrawn from the top of the oxidation vessel 160. The effluent 210 can include caustic, one or more hydrocarbons, one or more sulfur compounds, and a gas, and may have three phases. Typically, the effluent 210 can include a gas phase, a liquid disulfide phase, and a liquid aqueous caustic phase. Generally, the gas phase includes air with at least some oxygen depletion. In the gas phase, the oxygen content can be about 5—about 21%, by mole.

The effluent 210 can be received in the three-phase separator 220. The three-phase separator 220 can be any suitable process equipment, such as a disulfide separator. The three-phase separator 220 can include a stack 240 and a body 250. The three-phase separator 220 can be operated at any suitable conditions, such as no more than about 60° C., and about 250—about 500 kPa, preferably about 350—about 450 kPa.

The stack 240 can be any suitable dimension for receiving the three-phase effluent 210. Generally, the stack 240 is substantially cylindrical in shape having one or more walls surrounding a void. One or more elements 244, such as one or more trays, distributors, and/or packed beds, may be contained in the stack 240, as disclosed in, e.g., US 2012/0000826. Optionally, a wash oil may be provided to the stack 240.

In addition, the body 250 can have any suitable dimensions. Typically, the body 250 has a length and a height creating an interior space. Generally, the stack 240 is coupled to the body 250 at any suitable angle. Preferably, the stack 240 is connected at a substantially perpendicular orientation with respect to a length of the body 250.

One or more gases can pass upwards through the stack 240 and exit via a line 264. Generally, the total sulfur in the air exiting the stack 240 can be no more than about 100 ppm, by weight. As such, the gas can be sent or optionally blended with fuel gas for use as a fuel in a heater or furnace.

The liquids falling from the stack 240, such as, e.g., a wash oil, liquid disulfide, and aqueous caustic phases, can enter the body 250. The body 250 can contain a coalescer 260 within the interior space. Generally, the coalescer 260 can include one or more coalescer elements, which can include at least one of a metal mesh optionally coated, one or more glass fibers, sand, or an anthracite coal. The various liquid phases can pass through the coalescer 260 and be separated. Usually, the wash oil and the disulfide phase can exit via a line 270 to optionally enter a filter, such as a sand filter, to remove traces of caustic from an effluent.

Usually, at least a majority of the one or more disulfides are separated and removed from the caustic. Often, the caustic phase can exit the bottom of the disulfide separator as a disulfide-tainted caustic stream 268, which in this exemplary embodiment still may have excessive levels of disulfide, despite having a suitable level of mercaptan reduction.

The disulfide-tainted caustic stream 268 can be combined with a wash oil stream 280, which may include one or more C3-C12 hydrocarbons, such as propane, isobutene, normal butane, liquefied petroleum gas, naphtha, and non-alkene hydrocarbons, as well as a first recycle stream 344, as hereinafter described. The added wash oil stream 280 can aid the separation of the disulfides. The combined streams 268, 280, and 344 may be provided to a pump 290 and discharged as a disulfide-tainted caustic stream 284 to the vessel 300.

The vessel 300 can contain a coalescing element 320, which may be coupled within the vessel 300 in any suitable manner Moreover, the coalescing element 320 can be fitted into an existing vessel 300. The coalescing element 320 can include a mesh, usually made from carbon steel, stainless steel, or other metals or combination thereof Such metals can include one or more metals from groups 8-10 of the periodic table. Usually, the mesh can be about 0.3—about 0.6 meter thick as measured by the direction of fluid flow. Desirably, the coalescing element 320 provides further separation of any oils, such as disulfide oil, from the caustic. The disulfide oil and wash oil can agglomerate at the top of the vessel 300 and exit as a disulfide and wash oil stream 340. The stream 340 may be split into the first recycle stream 344 provided to the separated caustic stream 268 and the second recycle stream 348 provided to the combined stream 188.

A lean caustic stream 352 with reduced levels of disulfides can be withdrawn as a regenerated caustic stream 352 and combined with the stream 40 before being recycled to the extraction zone 120. Generally, the caustic stream 352 has about 5—about 25 wppm of disulfides with residence times ranging from about 10—about 20 minutes, preferably about 15 minutes.

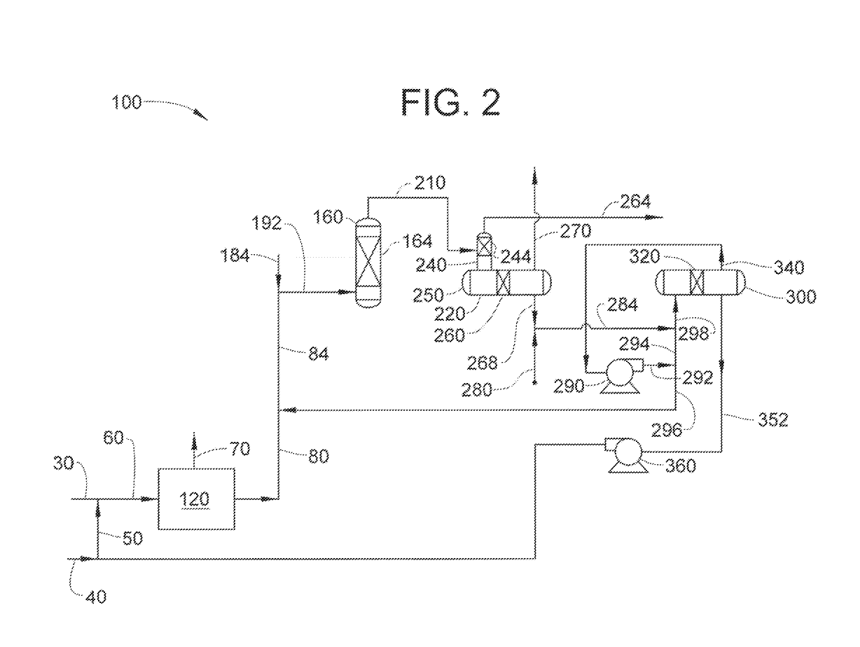

Referring to FIG. 2, another version of the exemplary apparatus 100 is depicted with the extraction zone 120, thiol oxidation vessel 160, three-phase separator 220, and vessel 300 as described above. In this exemplary embodiment, the separated disulfide-tainted caustic stream 268 may be combined with the wash oil stream 280 to form a combined stream 284. A first portion 294, hereinafter described, may be added to the combined stream 284 to form a unified stream 298 provided to the vessel 300. The wash oil and disulfides can separate and exit as the disulfide and wash oil stream 340 provided to the pump 290. The pump 290 can, in turn, provide a discharge 292 having a first portion 294 and a second portion 296. The first portion 294 may be added to the combined stream 284 to form the unified stream 298, while the second portion 296 may be combined with the caustic stream 80 to form a combined stream 84. Furthermore, the lean caustic stream 352 may be provided to a suction of a pump 360. The discharge of the pump 360 may be combined with the stream 40 to form the stream 50 added to the hydrocarbon stream 30 to create the extraction feed 60. This exemplary embodiment improves separation by eliminating the shear forces triggered by the centrifugal pump impellers. The shear forces may be eliminated by relocating the pumps 290 and 360 downstream of the vessel 300 for pulling material through the vessel 300 instead of pushing material to the vessel 300.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process for removing one or more disulfide compounds from a caustic stream, comprising:
passing the caustic stream, previously contacted with a hydrocarbon stream for removing one or more thiol compounds, through a vessel containing a coalescing element to remove the one or more disulfide compounds downstream of a three-phase separator and a thiol oxidation zone.

2. The process according to claim 1, wherein the coalescing element comprises a mesh.

3. The process according to claim 2, wherein the mesh comprises a stainless steel.

4. The process according to claim 2, wherein the mesh comprises a coating.

5. The process according to claim 4, wherein the mesh has a thickness of about 0.3—about 0.6 meter as measured by the direction of fluid flow.

6. The process according to claim 1, further comprising obtaining a disulfide stream from the vessel.

7. The process according to claim 6, further comprising passing the disulfide stream upstream of the thiol oxidation zone.

8. The process according to claim 6, further comprising recycling at least a portion of the disulfide stream to the vessel.

9. The process according to claim 1, further comprising providing an oxidized caustic stream from the thiol oxidation zone to the three-phase separator.

10. The process according to claim 9, further comprising obtaining a gas stream from a stack of the three-phase separator.

11. The process according to claim 9, further comprising obtaining a separated caustic stream from the three-phase separator.

12. The process according to claim 11, further comprising combining a wash oil stream with the separated caustic stream and providing the combined stream to the vessel.

13. A process for removing one or more disulfide compounds from a caustic stream, comprising:
A) obtaining the caustic stream containing one or more thiol compounds from an extraction zone;
B) passing the caustic stream to a thiol oxidation zone;
C) obtaining an oxidized caustic stream and sending the stream to a three-phase separator;
D) passing a separated caustic stream from the three-phase separator to a vessel containing a coalescing element to remove the one or more disulfide compounds;
E) obtaining a disulfide stream from the vessel; and
F) recycling the disulfide stream upstream of the thiol oxidation zone.

14. The process according to claim 13, wherein the coalescing element comprises a coated mesh.

15. The process according to claim 14, wherein the mesh comprises a coated stainless steel.

16. The process according to claim 14, wherein the coated mesh has a thickness of about 0.3—about 0.6 meter as measured by the direction of fluid flow.

17. A process for removing one or more disulfide compounds from a caustic stream, comprising:
A) obtaining the caustic stream containing one or more thiol compounds from an extraction zone;
B) passing the caustic stream to a thiol oxidation zone;
C) obtaining an oxidized caustic stream and sending the stream to a three-phase separator;
D) passing a separated caustic stream from the three-phase separator to a vessel containing a coalescing element to remove the one or more disulfide compounds;
E) obtaining a disulfide stream from the vessel; and
F) recycling at least a portion of the disulfide stream to the vessel.

18. The process according to claim 17, wherein the coalescing element comprises a coated mesh.

19. The process according to claim 18, wherein the coated mesh comprises a coated stainless steel mesh.

20. The process according to claim 18, wherein the mesh has a thickness of about 0.3—about 0.6 meter as measured by the direction of fluid flow.
